(19) United States
(12) Patent Application Publication
(10) Pub. No.: US 2025/0291718 A1
(43) Pub. Date: Sep. 18, 2025

(54) SEGMENTATION OF A FLASH TRANSLATION LAYER OF A NON-VOLATILE MEMORY DEVICE WITH LARGE STORAGE CAPACITY

(71) Applicant: Microchip Technology Incorporated, Chandler, AZ (US)

(72) Inventors: Saswati DAS, Milpitas, CA (US); Srinivas YELISETTI, Fremont, CA (US)

(21) Appl. No.: 19/079,714

(22) Filed: Mar. 14, 2025

Related U.S. Application Data
(60) Provisional application No. 63/565,526, filed on Mar. 14, 2024.

(51) Int. Cl. G06F 12/02

(52) U.S. Cl. CPC G06F 12/0246; G06F 2212/7201

(57) ABSTRACT

A controller may map different ranges of logical block addresses, of a flash translation layer of a storage device, to different segments; and map the different segments to different channels of the storage device. The controller may receive a command to perform a write operation on the storage device. The command may identify a range of logical block addresses. The controller may identify a segment, of the different segments, mapped to the range of logical block addresses; and perform the write operation using one or more channels, of the different channels, mapped to the identified segment.

### RELATED APPLICATION

This application claims priority to U.S. Provisional Patent Application No. 63/565,526 entitled “SEGMENTATION OF A FLASH TRANSLATION LAYER OF A NON-VOLATILE MEMORY DEVICE WITH LARGE STORAGE CAPACITY,” filed Mar. 14, 2024, which is incorporated herein by reference in its entirety.

### FIELD

The present disclosure generally relates to a flash translation layer of a non-volatile memory device. For example, the present disclosure relates to mapping logical block addresses to different segments in order to maintain a size of a logical to physical table and maintain a size of entries of the table.

### BACKGROUND

A non-volatile memory device may include a memory device that may store and retain data without external power supply. One example of a non-volatile memory device is a NAND flash memory device. The non-volatile memory device may store data that is used by a host computing device. A controller, associated with the non-volatile memory device, may maintain a table that maps logical block addresses (associated with the host computing device) to physical block addresses (of the non-volatile memory device). The table may be referred to as a logical to physical (L2P) table.

### SUMMARY

A method may comprise mapping different ranges of logical block addresses, of a flash translation layer of a storage device, to different segments; mapping the different segments to different channels of the storage device; receiving a command to perform a write operation on the storage device, wherein the command identifies a range of logical block addresses; identifying one or more segments, of the different segments, mapped to the range of logical block addresses; and performing the write operation using one or more channels, of the different channels, mapped to the identified one or more segments

A system comprising: a controller, of a storage device, to: receive a command to perform a write operation on the storage device, wherein the command identifies a range of logical block addresses of the storage device, wherein different ranges of logical block addresses, of the storage device, are mapped to different segments, and wherein the different segments are mapped to different channels of the storage device; identify one or more segments, of the different segments, mapped to the range of logical block addresses; and perform the write operation using one or more channels, of the different channels, mapped to the identified one or more segments

A computer program product may comprise: one or more computer readable storage media, and program instructions collectively stored on the one or more computer readable storage media, the program instructions comprising: program instructions to map different ranges of logical block addresses, of a flash translation layer of a storage device, to different segments; program instructions to map the different segments to different channels of the storage device; and program instructions to perform a write operation across the segments using one channel from each segment of the different segments.

### BRIEF DESCRIPTION OF THE DRAWINGS

FIGS. 1 and 2 illustrate an example implementation for variable-length entries in an L2P table that span more than one Dword in a cache line in the L2P table.

FIGS. 3A and 3B are diagrams of an example mapping as described herein.

FIG. 4 is a diagram of example components of one or more devices in which one or more examples described herein may be implemented.

FIGS. 5A and 5B are diagrams of examples breadth first programming sequence as described herein.

FIG. 6 is a flowchart of an example process associated with mapping different ranges of logical block addresses to different logical segments, with mapping the different logical segments to physical addresses of different channels, as described herein.

FIG. 7 illustrates an example of writing data to multiple channels and generating a corresponding fixed-length L2P entry in accordance with one or more implementations described herein.

### DETAILED DESCRIPTION

The following detailed description of example implementations refers to the accompanying drawings. The same reference numbers in different drawings may identify the same or similar elements.

A controller of a non-volatile memory device, such as a NAND flash memory device, may use a logical to physical (L2P) table to perform a mapping between logical block addresses (or logical addresses) and physical block addresses (physical addresses). The non-volatile memory device and the controller may be included in a storage device, such as a solid state drive (SSD). The L2P table may be stored on a memory of the controller, such as a random-access memory (RAM) or a dynamic RAM (DRAM).

The L2P table may include entries (referred to as “L2P entries”) that include information such as a logical address (and/or a pointer or index to a logical address) as well as a physical address. In one example, an L2P table may include 32-bit entries, where 22 bits of a 32-bit entry denotes a physical address. Such an L2P table would accordingly be able to refer to 4,194,304 (222) addresses. As the size of the storage device increases, the quantity of physical addresses may increase accordingly. In such examples, one potential solution is to increase the size of each L2P entry in order to accommodate the extra bits used to denote the additional physical addresses. For example, an SSD with a size exceeding 8TB or more may have physical addresses that would be unable to be represented with 22-bit addressing (e.g., 22 bits out of 32 bits used for the L2P table). For example, as the drive size increases, the size of the physical addresses mapped to (or corresponding to) the logical block addresses may increase to 33 bits, 34 bits and so on in order to accommodate the additional physical addresses of the drive resulting from the increased size.

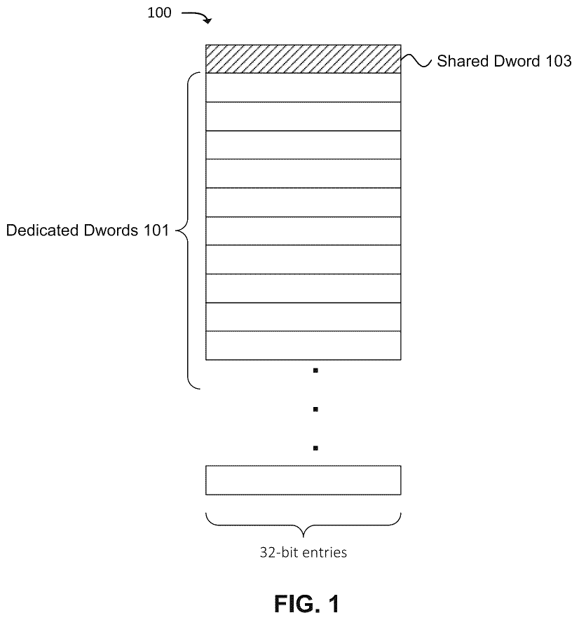

In situations where the L2P entries are larger than 32-bit, the L2P entries may result in more than a Dword being used for any given L2P entry. For example, as shown in FIG. 1, a portion of an L2P table may be stored in a physical cache line 100 of size 64 bytes, which includes 32-bit Dwords (e.g., dedicated Dwords 101 and a shared Dword 103). In situations where the L2P table has 32-bit L2P entries, each entry may be represented by a particular dedicated Dword 101. In situations where the L2P table has 33-bit (or more) L2P entries, each entry may be represented by a particular dedicated Dword 101 and a portion of the shared Dword 103. A “Dword,” as used herein, may refer to a data type with a size of 32 bits. For example, a “Dword” may be used to refer to a 32 bit unit of data.

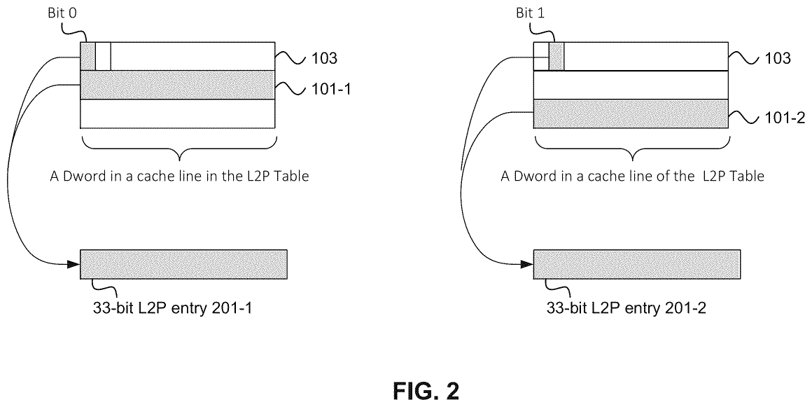

As shown in FIG. 2, a first 33-bit L2P entry 201-1 may be represented by all 32 bits (e.g., a Dword) of one 32-bit Dword 101-1 in the cache line 100, as well as a single bit (e.g., Bit 0) of the shared Dword 103. Similarly, a second 33-bit L2P entry 201-2 may be represented by all 32 bits of another 32-bit dedicated Dword 101-2, as well as a different single bit (e.g., Bit 1) of the shared Dword 103.

In some situations, the use of shared Dword 103 may result in wasted or unused cache space. In the example of FIG. 2, assume that the cache line 100 of the L2P table does not include additional L2P entries 201. In this example, 2 bits of the shared Dword 103 are used, while 30 bits of the shared Dword 103 are unused, thus resulting in wasted space of cache 100. Additionally, performing an L2P address lookup in this situation would include accessing multiple Dwords (e.g., a particular dedicated Dword in 101 as well as the shared Dword 103) to obtain the full L2P entry. While FIG. 2 provides an example in the context of 33-bit L2P entries represented in a cache line of size 64 byte in an L2P Table arranged in the granularity of cache lines (e.g., a cache that is implemented using 64 byte cache lines), similar issues may present themselves with L2P entries and/or caches lines of other sizes in which the L2P entries are larger than the size of a Dword. For example, similar issues may exist for 34-bit L2P entries on a 64 byte cache line, 35-bit L2P entries on a 64 byte cache line, 65-bit entries on a 64 byte cache line, and so on where L2P table is arranged in the granularity of cache lines so that L2P entries does not span across cache lines.

An increase of the size of the L2P entries from 32 bits to 33 bits (or more) causes an increase in the size of the L2P table. The increase of the size of the L2P entries may be caused by using 4 bits or more (instead of 2 or 3 bits) as a channel index to identify channels that connect the controller to the non-volatile memory device (e.g., a storage medium). The increase in the size of the L2P table increases the storage space utilized to store the L2P table in the memory of the controller. In some situations, the increase in the size of the L2P table may cause a current DRAM to be replaced with a DRAM with an increased size (e.g., an increased size with respect to a size of the current DRAM). Storing an L2P table, with a size that is greater than a portion of the memory (of the controller) allocated for storing the L2P table, may reduce read and write performance of the non-volatile memory device, since the L2P table entries would be loaded into memory during the processing of the read-write workload during operation of the non-volatile memory device. Upon initializing or powering up the storage device, the L2P table may be loaded to the memory from the non-volatile memory device. The read and write performance, in situations where the L2P table is of a greater size than the portion of the memory allocated for storing the L2P table, may be reduced due to an extra Nand read for loading the corresponding entries from the L2P table to the memory. Also, if the entire L2P table (with its increased size) is loaded to volatile memory during the boot up time, then it may increase the amount of time elapsed for the storage device to be ready for operation.

In some examples, the increase in the size of the L2P table may reduce over provisioning by increasing system data to be stored in the non-volatile memory device. Reducing the over provisioning may increase write amplification and may reduce the life of the storage device.

In some examples, the storage device may implement a sudden power loss protection (PLP) feature. In this regard, the storage device may implement journaling of L2P entries that are unaligned with respect to Dwords. As used herein, “journaling” (of L2P entries) may refer to keeping a record of the L2P entries. In some examples, information identifying the L2P entries may be stored in a memory of the storage device. For example, the information may be stored in a log (also referred to as a “journal log”). Journaling of the unaligned L2P entries may consume central processing unit cycles, which may lead to additional reduction of write performance. In some situations, journal log replay of Dword-unaligned L2P entries may require atomic read modify write operations, thereby significantly increasing the L2P table recovery time and time to ready (TTR) after a PLP boot up. The PLP feature is a feature that supports sudden power loss or abrupt shutdown of the device. During sudden power loss, the device cannot save the entire L2P Table to the non-volatile space. As such, upon boot up from a sudden power loss, the L2P table would need to be recovered through journal log replay. As used herein, “journal log replay” may refer to reading information stored in a journal log and using the information to perform a recovery of the L2P table.

Currently, the storage device may be programmed using a depth first programming model. In this regard, a large sequential write command is spread to the non-volatile memory device in a depth first order. With a depth first programming approach, a low queue depth (QD) large sequential read command may suffer significant latency, because reading and writing to the non-volatile memory device via multiple channels is typically performed in series. For example, data may be written, via a first channel, to a lower page, followed by a middle page, and then an upper page.

Subsequently, data may be written, via a second channel, to a lower page, followed by a middle page, and then an upper page. In some situations, multiple commands (e.g., for read operations and for write operations) may be provided in order to engage the different channels. The data may be read in a similar manner. In other words, Tread and Channel Dout may be serialized, where “Tread” is the time to read a page or section of a page from the storage media and “Dout” is the time to transfer a section of data from the storage device to DRAM or SRAM memory through the channel connect to the storage media. Writing and reading data in this manner may cause latency with respect to write and read operations.

For at least the foregoing reasons, increasing the size of the L2P table may cause several technical problems, such as reduction of cache utilization, reduction of over provisioning, writing amplification, reduction of write performance, and reduction of the life of the storage device, among other examples.

Implementations described herein are directed to a technical solution that solves the technical problems mentioned above. For example, implementations described herein are directed to a technical solution that includes dividing logical address space into multiple logical segments and mapping such logical segments to flash channels of a storage device. For instance, different ranges of logical block address may be mapped to different segments. Additionally, the different segments may be mapped to different channels of the storage device.

In some embodiments, a segment number specifies which set of channels with which a range of logical block address is associated. The ranges of logical block addresses mapped to a segment are configurable based on the number of planes in a non-volatile memory device. Segment to channel mapping is also configurable based on the number of segments utilized to address the large drive size and the number of channels in the controller.

By dividing the logical block address space, implementations described herein maintain the size of the L2P entries fixed to a Dword and aligns the L2P entries to a Dword and solve the problems of Dword unaligned L2P entries and thus keep the size of the L2P table fixed irrespective of the size of the portion of the memory allocated for storing the L2P table. As used herein, “aligned” (as used with respect to a size of an L2P entry and a Dword) may be refer to the size of the L2P entry being equal to (or less than) a size of the Dword. As used herein, “unaligned” (as used with respect to a size of an L2P entry and a Dword) may be refer to the size of the L2P entry exceeding a size of the Dword, such that more than one Dword is used to store the L2P entry. As explained herein, by dividing the logical block address space, implementations described may enable the use of 2 bits (of an L2P entry) to identify a channel within a segment instead of using 4 bits or more as a channel index, By using 2 or 3 bits to identify a channel within a segment, implementations described herein may maintain a size of an L2P entry at 32 bits (as opposed to 33 bits or more). Accordingly, the size of the L2P entry may be aligned with a Dword.

Implementations described herein are also directed to a breadth-first programming approach where data across the channels in a segments are programmed together in parallel (e.g., batch programming).

For maximum utilization of channel bandwidth, the design of L2P table segmentation ensures that sequential write data are spread across multiple segments. For example, for a 4-segment SSD Drive, a sequential write data (e.g., 128KB) may be spread across lower pages of 4 non-volatile memory devices (e.g., dies) in 4 channels belonging to 4 different segments, for a 2 planes storage device. Additional sequential data may be spread across lower pages of the 4 dies in 4 additional channels each channel belonging to each of the 4 different segments. More sequential data may be spread across lower pages of the 4 non-volatile memory devices in 4 additional channels belonging to the 4 different segments. Consequently, sequential read operations can also be performed in parallel across the channels in a similar manner, thereby maximizing the read performance through channel parallelism.

By introducing the concept of breadth-first programming sequence within each segment, the invention significantly reduces the latency of low QD large sequential read commands by spreading sequential data across multiple channels in multiple segments and parallelizing the channel bandwidth. As used herein, “QD” may refer to a quantity of simultaneous commands (e.g., read commands and write commands). This new design can achieve substantial sequential read performance by engaging all the channels with minimum number of outstanding read command contexts thereby reducing cache memory requirement in the controller. Implementations described herein may achieve faster sequential read performance for 128K and other large sequential read commands with reduced outstanding commands in a controller cache, due to channel parallelism.

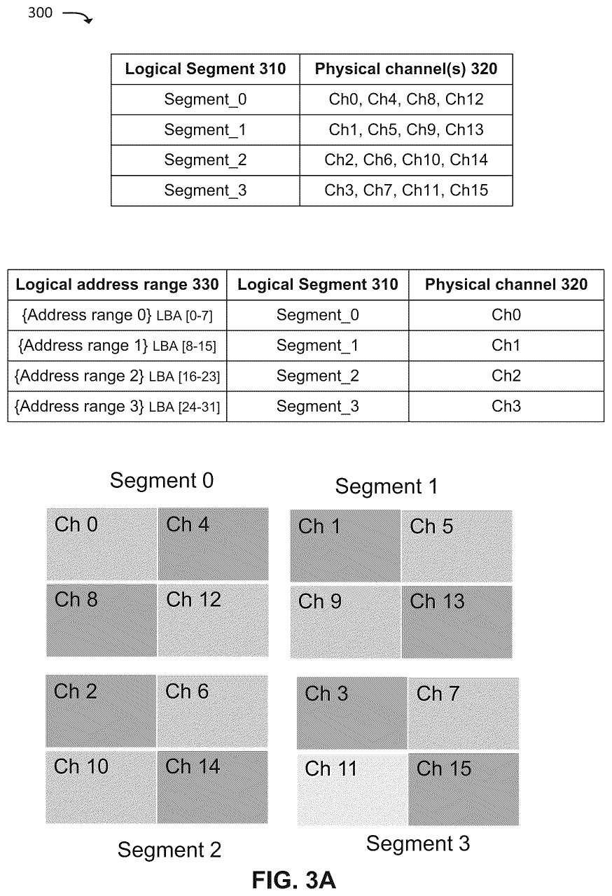

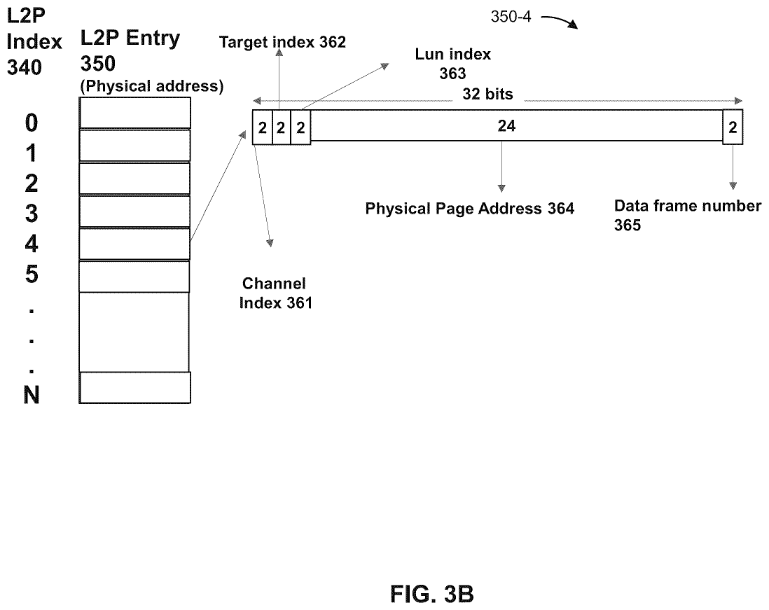

FIGS. 3A and 3B are diagrams of an example mapping 300 described herein. As shown in FIG. 3A, a logical address space may be divided into different logical segments. The different logical segments may be mapped to different channels (also referred to as “physical channels”) connected to storage media of a storage device. Different ranges of logical block addresses (LBAs) may be mapped to different segments. In some examples, mapping 300 may be stored in a data store, such as a data structure, a database, or a linked list, without limitation. The data store may be stored in a memory of a controller of the storage device. In some examples, mapping 300 may not be stored as explained below.

As shown in FIG. 3A, each logical segment may be mapped to a set of physical channels of the storage device. In some implementations, each physical channel may correspond to a particular storage medium of the storage device. In this example, Segment_0 is mapped to one set of channels (e.g., the four example channels Ch0, Ch4, Ch8, and Ch12), Segment_1 is mapped to another set of channels (e.g., the four example channels Ch1, Ch5, Ch9, and Ch13), and so on. In some examples, a number of channels mapped to a segment may be based on the number of channels and the number of segments. For example, if the number of channels is 16 and the number of segments is 4, then 4 channels may be mapped to each segment (e.g., 16 channels divided by four segments).

As further shown in FIG. 3A, different logical segments may be identified for different ranges of logical block addresses. For example, a first range of logical block addresses (shown as “{Address range 0}” which includes a range of LBAs 0-7) may be mapped to a first segment (shown as “Segment_0”), a second range of logical block addresses (shown as “{Address range 1}” which includes a range of LBAs 8-15) may be mapped to a second segment (e.g., “Segment_1”), and so on. In some examples, a segment number may be identified based on a logical block address and a number of segments. For example, a segment number may be identified based on a bit shift of a logical block address and a number of segments. For instance, a segment number may be identified based on the following formula:

$$( LBA ≫ 3 ) \& ( Number of segments - 1 )$$

In other words, a segment number may be identified by performing a 3 bit right shift on a logical block address and by performing a logical AND operation on a result of the 3 bit right shift and a value that is one less than the number of segments. For example, if the logical block address is 1000 (or the binary value of 8) and the number of segments is 4, performing a 3 bit right shift of the logical block address will result in the value 01. A logical AND operation will be performed using the value 01 and the value of 11 (or the binary value of 3, which is one less than the number of segments), which will result in the value 01 (or the binary value of 1). As a result, the segment number for the logical block address 1000 will be segment 01 or segment 1. As further shown in FIG. 3A, different channels may be identified for the different ranges of logical block addresses. For example, a first channel (e.g., channel Ch0) may be mapped to the first range of logical block addresses, a second channel (e.g., channel Ch1) may be mapped to a second range of logical block addresses, and so on. The above mapping may be an example mapping for a storage device with a two-plane configuration. FIG. 3A illustrates a visualization of the above mapping of the different segments to the different sets of channels.

FIG. 3A illustrates one example mapping between logical addresses (e.g., ranges of logical addresses), logical segments, and physical channels. In practice, other mappings may be performed in accordance with the techniques described herein. For example, in another example implementation, two address ranges may be mapped to two logical segments (where each logical segment is mapped to one or more physical channels). As another example, eight address ranges may be mapped to eight logical segments, and so on.

In some examples, the different ranges of logical block addresses may be mapped to different segments based on a number of planes of a storage medium of the storage device. Examples described have been provided with respect to storage media with two planes. In some examples, the different segments may be mapped to the different channels based on the number of segments used to address a logical address space of the storage device and based on a number of channels associated with a controller of the storage device. For example, for a configuration involving two segments, a first half of the channels may be mapped to a first segment and a second half of the channels may be mapped to a second segment. In some examples, the first half of the channels may include even number channels and the second half may include odd number channels, or vice versa.

The mapping of segments to physical channels and of logical block addresses to segments may enable the use of 2 bits (instead of 3 bits or more) to identify a channel, as illustrated in FIG. 3B. FIG. 3B illustrates a portion of an L2P table. In some examples, different L2P indexes 340 may identify different L2P entries 350 which include physical addresses. For example, L2P entries 350 may identify physical addresses of physical locations of the storage device. As explained herein, a physical address includes a channel index, a target index, a logical unit number, a physical page address, and a data frame number. An example L2P entry 350-4 is illustrated in FIG. 3B. L2P entry 350-4 may be identified by a particular L2P index 340. L2P entry 350-4 may be determined (or generated) by a controller of the storage device based on a logical block address provided by a host device.

As shown in FIG. 3B, L2P entry 350-4 may include a physical address, which may include a channel index 361, a target index 362, a logical unit number 363, a physical page address 364, and a data frame number 365. Channel index 361 may identify a channel within a particular segment (e.g., an index of a channel within the particular segment). As shown in FIG. 3A for example, channel Ch 0 may be provided at a channel index 0 of the first segment (segment 0), channel Ch 4 may be provided at a channel index 1 of the first segment (segment 0), channel Ch 8 may be provided at a channel index 2 of the first segment (segment 0), and so on. Referring back to FIG. 3B, because channel index 361 identifies an index of a channel within a particular segment (as opposed to a channel of all possible channels connected to the storage media), channel index 361 may include 2 bits (or in some instance 3 bits). The 2 bits may help maintain a size of L2P entry 350-4 at 32 bits. Target index 362 may identify a target of the storage device (e.g., a storage medium of the storage device). LUN index 363 may identify a LUN of the storage device. As shown in FIG. 3B, target index 362 and LUN index 363 may each include 2 bits.

Physical page address 364 may identify an address of a physical page of the storage medium. As shown in FIG. 3B, physical page address 364 may include 24 bits. In some examples, physical page address 364 may be determined based on a number of blocks of the storage medium and the number of pages per block. Data frame number 365 may identify a data frame, of the physical page, that stores data associated with L2P entry 350-4. As shown in FIG. 3B, L2P entry 350-4 may include 32 bits.

In some implementations, the controller may determine a segment number of a segment based on the logical block address used to generate L2P entry 350-4, as explained herein. The controller may determine a logical block address range that includes the logical block address. The controller may determine a segment mapped to the logical block address range and determine a channel, of the segment, mapped to the logical block address range. The controller may determine channel index 361 based on the segment and the channel. For example, if the channel is a first channel of the segment then channel index 361 may have a value of 0, if the channel is a second channel of the segment then channel index 361 may have a value of 1, and so on. In some examples, the controller may determine a channel number of a channel to be mapped to a segment (e.g., to be mapped to a particular index of the segment) based on channel index 361 of the particular index, the number of segments, and the segment number of the segment. For example, the controller may determine the channel number of the channel based on a mathematical combination of channel index 361, the number of segments, and the segment number. For instance, the controller may determine the channel number based on the following formula:

channel index within the segment*number of segments+segment_number,

where channel index within the segment represents channel index 361, number of segments represents the number of segments, and segment_number represents the segment number.

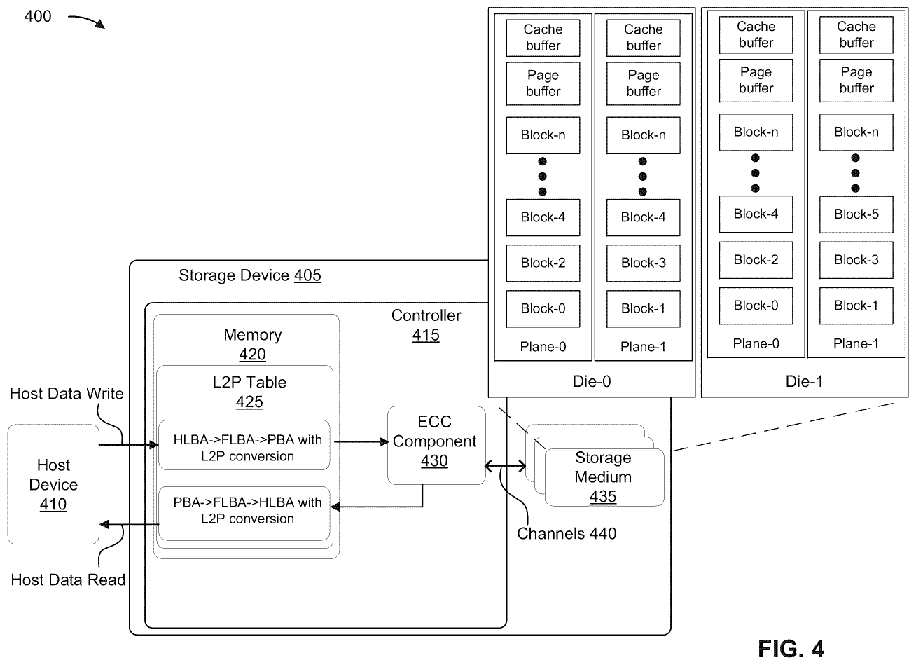

FIG. 4 is a diagram of an example implementation 400 described herein. Example implementation 400 describes components and operations associated with a storage device 405. In some implementations, storage device 405 may include an SSD. As shown in FIG. 4, storage device 405 may be associated with a host device 410. Host device 410 may access data (also referred to as “host data”) stored by storage device 405. For example, as shown in FIG. 4, host device 410 may initiate a host data write operation (e.g., a write operation) to write the host data to storage device 405 (e.g., to store the data on storage device 405) and may initiate a host read operation (e.g., a read operation) to read the host data from storage device 405.

Host device 410 may include one or more devices capable of receiving, generating, storing, processing, and/or providing information associated with generating an L2P data structure (or L2P table), as described elsewhere herein. The host device 410 may include a communication device and a computing device. For example, the host device 410 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

As shown in FIG. 4, storage device 405 may include a controller 415. Controller 415 may include one or more of an application specific integrated circuit (ASIC) or firmware. Controller 415 may cause functions to be performed on storage device 405, such as read operations, write operations, erase operations, garbage collection operations, among other examples. Controller 415 may include a memory 420 and an error correction code (ECC) component 430. Memory 420 may include a RAM (e.g., dynamic random access memory (DRAM), a synchronous DRAM (SDRAM), among other examples).

As shown in FIG. 4, memory 420 may include an L2P table 425 (or an L2P data structure). L2P table 425 may store a mapping between host logical block addresses (or logical addresses identified by host device 410) and physical block addresses (or physical addresses of non-volatile memory devices of storage device 405). In some implementations, L2P table 425 may be generated by controller 415. As discussed above, in accordance with some implementations described herein, L2P table 425 may be generated in a Dword-aligned manner, such that a relatively large quantity of logical addresses may be mapped to separate channels or sets of channels (e.g., multiple storage mediums 435 may be used to store user data associated with a given logical address).

In some implementations, controller 415 may identify a host logical block address (HLBA) associated with the host data by which host device 410 may reference the host data in a future read operation. As shown in FIG. 4, controller 415 may convert the HLBA to a flash logical block address (FLBA) or other local logical block address, and then may link the FLBA to one or more physical block addresses (PBA) using an L2P conversion, as discussed above. Conversely, controller 415 may convert one or more PBAs to an FLBA or other local logical block address, and then may link the FLBA to one or more physical block addresses using an L2P conversion. In this way, the host device may send a static address associated with the host data, controller 415 may link the address known to host device 410 to an address known to storage device 405 (the FLBA), and may link the address known to storage device 405 to a physical address of the host data within a storage medium of storage device 405.

Controller 415 may store the links between the HLBA, the FLBA, and the PBA in L2P table 425. In some aspects, the host data may be moved within the storage medium or between storage mediums of storage device 405, which controller 415 may note in the link between the FLBA and the physical location. In this way, the HLBA may bypass being updated when the host data is moved to a new PBA.

ECC component 430 may include an ECC engine. ECC component 430 may perform error correction code encoding on the host data. In some implementations, the error correction code encoding may include adding redundancy, parity bits, or other information that can later be used to identify errors in the host data when read from the storage medium. Controller 415 may provide the host data, after encoding, via flash control channels (not shown) to write on storage mediums of storage device 405. In some implementations, ECC component 430 may perform decoding on data obtained from storage device 405. In some examples, one or more components of controller 415 may form a flash translation layer of storage device 405. As used herein, a “flash translation layer” may refer to a system that manages operations on storage device 405. For example, the flash translation layer may perform tasks such as address translation, garbage collection, wear-leveling, error correction, among other examples.

As shown in FIG. 4, storage device 405 may include storage mediums 435 (individually “storage medium 435” and collectively “storage mediums 435”). A storage medium 435 may include a non-volatile memory device. For example, the storage medium 435 may include a NAND memory device. In some situations, storage mediums 435 may be organized by data pools. A “data pool” may be used to refer to part of a storage medium 435 that stores a given type of data (e.g., SLC data, MLC data, and TLC data, without limitation).

As shown in FIG. 4, a storage medium 435 may include multiple dies. In some implementations, a die may include multiple planes. A plane may include multiple memory blocks (also referred to as “block”), one or more page buffers (associated with the blocks), and one or more cache buffers. In some implementations, each storage medium 435 may correspond to, or may be connected to, a particular respective channel 440. In this regard, the controller 415 may communicate with one or more connected storage media 435 via one or more channels 440. For example, the controller 415 may perform or initiate a read or write operation at a physical location of a storage medium 435. For example, controller 415 may receive a command to perform a write operation on storage device 405, may determine the physical location based on the command, and may perform the write operation at the physical location. In some examples, the write operation may be performed via different channels of different storage media. In some situations, the different channels may be mapped to different segments.

As indicated above, FIG. 4 is provided as an example. Other examples may differ from what is described with regard to FIG. 4. The number and arrangement of devices shown in FIG. 4 is provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

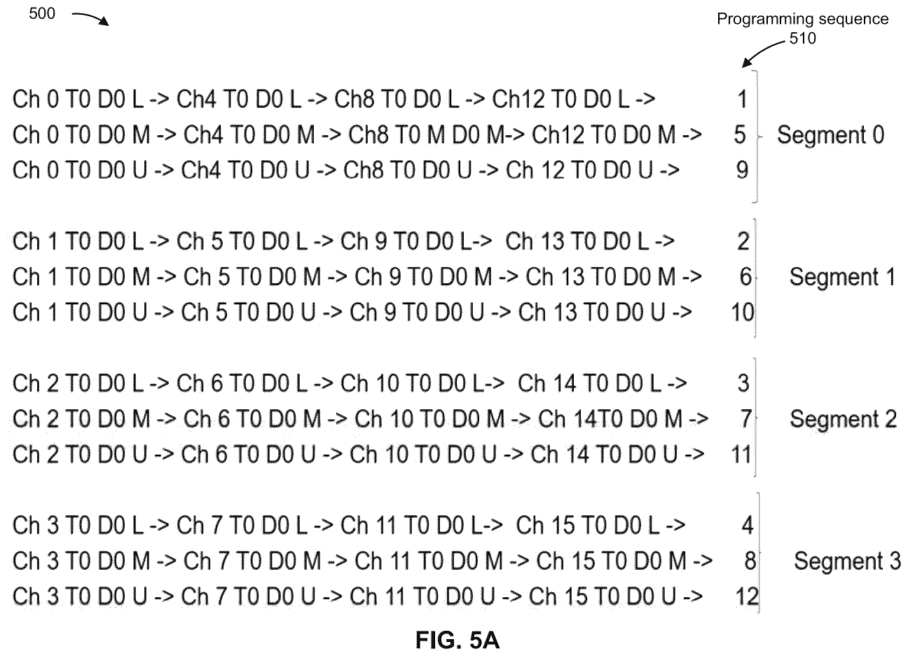

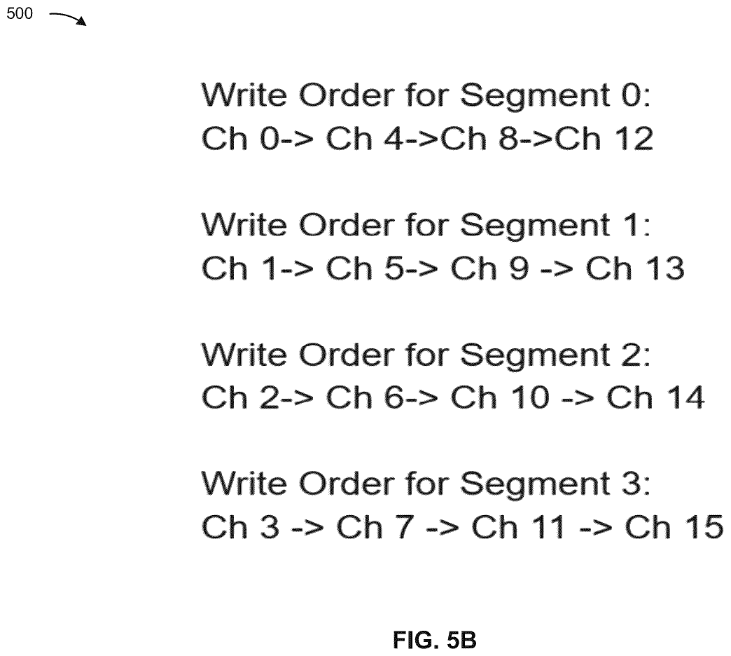

FIGS. 5A and 5B are diagrams of examples 500 of breadth first programming sequence. In contrast to depth first programming, a large sequential write command is spread to storage media of a storage device using a breadth first programming sequence. With the breadth first programming, reading and writing data to the storage media via multiple channels is performed in parallel. Data (belonging to a segment) is programmed via the channels of the segment for different pages of storage media connected to the channels.

For example, first portion of data (of the large sequential write command) may be written, via channels of a first segment (segment 0), to a lower page of first storage media. As shown in FIG. 5A, the channels of the first segment include Ch 0, Ch 4, Ch 8, and Ch 12. Subsequently, second portions of data (of the large sequential write command) may be written, via channels of a second segment (segment 1), to a lower page of second storage media, As shown in FIG. 5A, the channels of the second segment include Ch 1, Ch 5, Ch 9, and Ch 13. Subsequently, third portions of data (of the large sequential write command) may be written, via channels of a third segment (segment 2), to a lower page of third storage media, and so on, The channels of the third segment include Ch 2, Ch 6, Ch 10, and Ch 14.

The above sequence of programming is identified by a programming sequence 510. As indicated by programming sequence 510, fourth portions of data (of the large sequential write command) may be written, via the channels of the first segment (segment 0), to a middle page of the first storage media after data has been to all lower pages of the storage media mentioned above. As indicated by programming sequence 510, fifth portions of data (of the large sequential write command) may be written, via the channels of the first segment (segment 0), to an upper page of the first storage media after data has been to all middle pages of the storage media mentioned above.

In some implementations, the programming may be performed in batches. For example, for a first batch, data may be written to the lower page of multiple storage media connected to the channels of the segments. In a second batch, data may be written to the middle page of the multiple storage media connected to the channels of the segments, and so on. By using breadth first programming and batch programming within each segment, implementations described herein significantly reduces the latency of low QD large sequential read commands by spreading writing (or reading) the data across multiple storage media and using the channels in parallel. Implementations described herein may utilize all the channels with a reduced number of outstanding read commands, thereby reducing cache memory requirement in the controller. Using breadth first programming, 128K sequential write data may be spread across lower pages of 4 storage media (or dies) with 2 planes, using 4 channels for the 2 planes.

In some situations, a write operation may be initiated in a sequence for channels of a segment. As shown in FIG. 5B for example, for the first segment (segment 0), the write operation may be initiated on a first channel (Ch 0) of the first segment, followed by a second channel (Ch 0) of the first segment, and so on. While the write operation may be initiated in a sequence, the write operation may proceed to being performed in parallel via the channels of the first segment. While implementations herein have been described with respect to programming (or write) operations, implementations described herein are applicable to read operations.

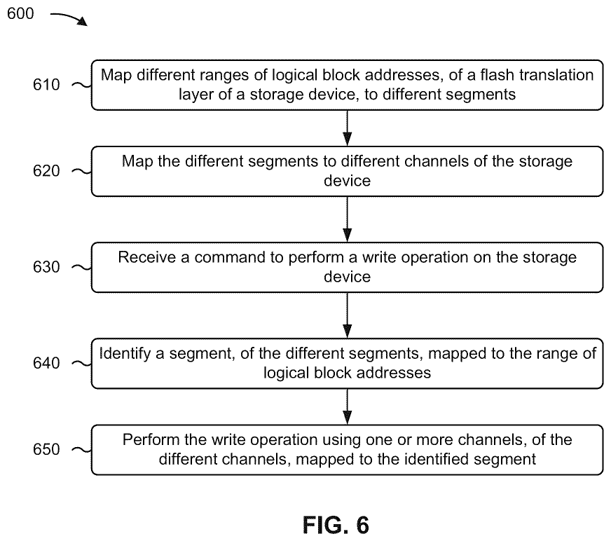

FIG. 6 is a flowchart of an example process 600 associated with mapping different ranges of logical block addresses to different segments and is associated with mapping the different segments to different channels of the storage component. In some implementations, one or more process blocks of FIG. 6 may be performed by a controller of a storage device (e.g., controller 415 of storage device 405). Accordingly, the operations of process 600 are described below in the context of being performed by controller 415. In some implementations, one or more operations of FIG. 6 may be performed by another device or a group of devices in conjunction with, in addition to, or in lieu of controller 415.

As shown in FIG. 6, process 600 may include mapping (at 610) different ranges of logical block addresses, of a flash translation layer of a storage device, to different logical segments. For example, controller 415 may map different ranges of logical block addresses, of a flash translation layer of a storage device, to different segments, as described above in connection with FIG. 3A.

Process 600 may further include mapping (at 620) the different segments to different channels of the storage device. For example, controller 415 may map the different segments to different channels of the storage device, as described above in connection with FIG. 3A.

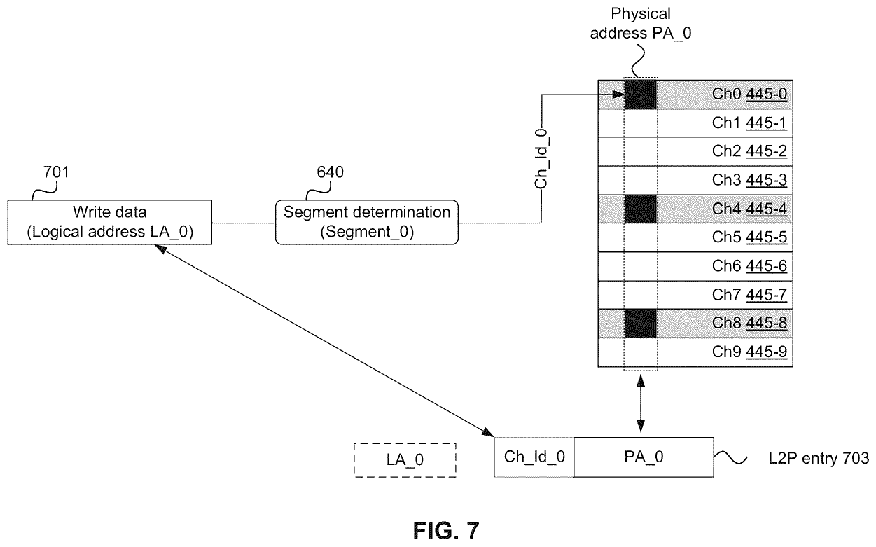

Process 600 may additionally include receiving (at 630) a command (e.g., from host device 410 and/or some other suitable device) to perform a write operation on the storage device. For example, controller 415 may receive a command to perform a write operation on the storage device, as described above in connection with FIG. 4. The command may include one or more logical block addresses. For example, as shown in FIG. 7, particular write data 701 (e.g., user data to be written to storage device 405) may be received. A particular logical address (e.g., LA_0) may be received with write data 701, and/or may otherwise be determined by controller 415. While write data 701 is described herein as including one logical address, similar concepts may be applied when the write data specifies multiple logical addresses.

Returning to FIG. 6, process 600 may include identifying (at 640) a logical segment, of the different logical segments, to which the logical address has been mapped. For example, as discussed above, different segments may be associated with different logical addresses or ranges of logical addresses. In the example of FIG. 7 and referring to example mapping 300, assume that logical address LA_0 associated with the received write data 701 falls within {Address range 0}, which is associated with logical segment Segment_0.

Returning to FIG. 6, process 600 may further include performing (at 650) the write operation to one or more channels that are associated with the identified logical segment. Referring to the example of data structure 300 and continuing with the example shown in FIG. 7, the identified logical segment Segment_0 may be associated with (e.g., mapped to) channels Ch0, Ch4, Ch8, and/or one or more other channels. Further, in this example and as noted above, each channel may be associated with a respective storage medium 435. For example, channel Ch0 maybe associated with storage medium 435-0, channel Ch1 maybe associated with storage medium 435-1, channel Ch2 maybe associated with storage medium 435-2, channel Ch3 maybe associated with storage medium 435-3, channel Ch4 maybe associated with storage medium 435-4, channel Ch5 maybe associated with storage medium 435-5, channel Ch6 maybe associated with storage medium 435-6, channel Ch7 maybe associated with storage medium 435-7, channel Ch8 maybe associated with storage medium 435-8, channel Ch9 maybe associated with storage medium 435-9, and so on.

Controller 415 may, for example, utilize the same physical address at each channel when performing the write operation. For example, each channel may include or may be associated with the same address space, and different portions or chunks of write data 701 may be written to the same physical address (PA_0) on multiple channels. For example, one portion of write data 701 may be written to physical address PA_0 on channel Ch0, another portion of write data 701 may be written to physical address PA_0 on channel Ch4, another portion of write data 701 may be written to physical address PA_0 on channel Ch8, and so on. In some implementations, the writes to the separate channels may be performed in a sequential manner. In some embodiments, multiple chunks of write data 701 may be written to multiple corresponding channels in parallel.

FIG. 7 further illustrates L2P entry 703, which corresponds to write data 701 as written to storage device 405 (e.g., to storage mediums 435-0 and/or to channels Ch0). L2P entry 703 may, for example, may be indexed by the logical address (LA_0) of write data 701, and specify the channel index Ch_Id_0 within the logical segment (Segment_0) of write data 701, and the physical address (PA-0) on the channel to which a portion of write data 701 has been written. In some implementations, the logical address indicated in L2P entry 703 may be specified as an index, a reference, or some other identifier. Additionally, or alternatively, in some implementations, the segment number of the logical address may be obtained from the mapping in FIG. 3A.

By using the segment number as obtaining from the mapping in FIG. 3 and channel index in the L2P entry to identify the channel number of the physical address, L2P entries (such as L2P entry 703) of L2P table 425 may be able to be implemented as fixed length entries. As such, L2P tables implemented by a cache of a given size (e.g., cache 100 with 32 bits assigned per entry) may be able to represent larger storage devices 405 (e.g., with more physical blocks that can store more user data), without needing to resort to splitting up L2P entries as shown in FIG. 2 (e.g., using larger or variable-length L2P entries such as 33-bit L2P entries 201-1 or 201-2). That is, the same cache 100 that has been used to represent physical addresses in the absence of the segment and channel-index within segment based techniques described above, may be used to represent even more physical addresses by using the segment and channel-index within segment based techniques described above. Such techniques may accordingly be Dword-aligned, providing for a one-step (e.g., faster) physical address lookup for both write and read operations. For example, for reading or writing large data (e.g., that spans multiple channels), using the logical block address to segment number mapping of FIG. 3 a to identify the segment number and a single lookup may be performed on L2P table 425 to identify multiple physical channels associated with the large data.

In some implementations, mapping the different segments to the different channels comprises mapping a first segment of the different segments to a first channel and a second channel of the different channels, and mapping a second segment of the different segments to a third channel and a fourth channel of the different channels.

In some implementations, the first channel and the second channel are not sequential channels, and wherein the third channel and the fourth channel are not sequential channels.

In some implementations, mapping the different ranges of logical block addresses to the different segments comprises mapping a first range of logical block addresses to a first segment of the different segments, and mapping a second range of logical block addresses to a second segment of the different segments.

In some implementations, performing the write operation comprises performing the write operation on a first lower page of the storage device using a first channel of the one or more channels, and performing the write operation on a second lower page of the storage device using a second channel of the one or more channels.

In some implementations, performing the write operation comprises performing the write operation on a first middle page of the storage device using the first channel after performing the write operation on the first lower page and on the second lower page, and performing the write operation on a second middle page of the storage device using the second channel after performing the write operation on the first lower page and on the second lower page.

In some implementations, process 600 includes mapping the different ranges of logical block addresses to the different segments and mapping the different segments to the different set of channels to maintain a size of entries, of a logical to physical table, independently of a size of the storage device, wherein the entries are associated with the logical block addresses.

In some implementations, process 600 includes mapping the different ranges of logical block addresses to the different segments and mapping the different segments to the different set of channels to maintain a size of a logical to physical table independently of a size of the storage device, wherein the logical to physical table is associated with the logical block addresses.

Although FIG. 6 shows example operations of process 600, in some implementations, process 600 may include additional operations, fewer operations, different operations, or differently arranged operations than those depicted in FIG. 6. Additionally, or alternatively, two or more of the operations of process 600 may be performed in parallel.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems or methods described herein may be implemented in different forms of hardware, firmware, or a combination of hardware and software. The actual specialized control hardware or software code used to implement these systems or methods is not limiting of the implementations. Thus, the operation and behavior of the systems or methods are described herein without reference to specific software code-it being understood that software and hardware can be used to implement the systems or methods based on the description herein.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. A method comprising:
mapping different ranges of logical block addresses, of a flash translation layer of a storage device, to different segments;
mapping the different segments to different channels of the storage device;
receiving a command to perform a write operation on the storage device,
wherein the command identifies a range of logical block addresses;
identifying one or more segments, of the different segments, mapped to the range of logical block addresses; and
performing the write operation using one or more channels, of the different channels, mapped to the identified one or more segments.

2. The method of claim 1, wherein mapping the different segments to the different channels comprises:
mapping a first segment of the different segments to a first channel and a second channel of the different channels; and
mapping a second segment of the different segments to a third channel and a fourth channel of the different channels.

3. The method of claim 2, wherein the first channel and the second channel are not sequential channels, and
wherein the third channel and the fourth channel are not sequential channels.

4. The method of claim 1, wherein mapping the different ranges of logical block addresses to the different segments comprises:
mapping a first range of logical block addresses to a first segment of the different segments; and
mapping a second range of logical block addresses to a second segment of the different segments.

5. The method of claim 1, wherein performing the write operation comprises:
performing the write operation on a first lower page of a first storage medium using a first channel of the one or more channels of a first segment of the one or more segments; and
performing the write operation on a first lower page of a second storage medium using a first channel of the one or more channels of a second segment of one or more segments.

6. The method of claim 5, wherein performing the write operation within the first segment comprises:
performing the write operation on a first lower page of a third storage medium using a second channel of the first segment after performing the write operation on the first lower page of the first storage medium; and
performing the write operation on a first middle page of the first storage medium using the first channel after performing the write operation on the first lower page of the third storage medium.

7. The method of claim 1, comprising:
mapping the different ranges of logical block addresses to the different segments and mapping the different segments to the different channels to maintain a size of entries, of a logical to physical table, independently of a size of the storage device,
wherein the entries are associated with the logical block addresses.

8. The method of claim 1, comprising:
mapping the different ranges of logical block addresses to the different segments and mapping the different segments to the different channels to maintain a size of a logical to physical table independently of a size of the storage device,
wherein the logical to physical table is associated with the logical block addresses.

9. A system comprising:
a controller, of a storage device, to:
receive a command to perform a write operation on the storage device,
wherein the command identifies a range of logical block addresses of the storage device,
wherein different ranges of logical block addresses, of the storage device, are mapped to different segments, and
wherein the different segments are mapped to different channels of the storage device;
identify one or more segments, of the different segments, mapped to the range of logical block addresses; and
perform the write operation using one or more channels, of the different channels, mapped to the identified one or more segments.

10. The system of claim 9, wherein the different ranges of logical block addresses are mapped to the different segments and the different segments are mapped to the different channels to maintain a size of a logical to physical table independently of a size of the storage device, and
wherein the logical to physical table is associated with the logical block addresses.

11. The system of claim 9, wherein the different ranges of logical block addresses are mapped to the different segments and the different segments are mapped to the different channels to maintain a size of entries, of a logical to physical table, independently of a size of the storage device, and
wherein the entries are associated with the logical block addresses.

12. The system of claim 11, wherein, to perform the write operation, the controller is to:
perform the write operation on a first lower page of a first storage medium of the storage device using a first channel of the one or more channels of a first segment of the one or more segments; and
perform the write operation on a first lower page of a second storage medium of the storage device using a first channel of the one or more channels of a second segment of the one or more segments.

13. The system of claim 12, wherein, to perform the write operation within the first segment, the controller is to:
perform the write operation on a first lower page of a third storage medium of the storage device using a second channel of the first segment after performing the write operation on the first lower page of the first storage medium; and
perform the write operation on a first middle page of the first storage medium using the first channel after performing the write operation on the first lower page of the third storage medium.

14. The system of claim 9, wherein the controller is to:
map a first segment of the different segments to a first channel and a second channel of the different channels; and
map a second segment of the different segments to a third channel and a fourth channel of the different channels.

15. The system of claim 14, wherein the first channel and the second channel are not sequential channels, and
wherein the third channel and the fourth channel are not sequential channels.

16. The system of claim 9, wherein the controller is to:
map a first range of logical block addresses to a first segment of the different segments; and
map a second range of logical block addresses to a second segment of the different segments.

17. A computer program product comprising:
one or more computer readable storage media, and program instructions collectively stored on the one or more computer readable storage media, the program instructions comprising:
program instructions to map different ranges of logical block addresses, of a flash translation layer of a storage device, to different segments;
program instructions to map the different segments to different channels of the storage device; and
program instructions to perform a write operation across the segments using one channel from each segment of the different segments.

18. The computer program product of claim 17, wherein, the program instructions to map the different segments to the different channels of the storage device comprise:
program instructions to map a first segment of the different segments to a first channel and a second channel of the different channels; and
program instructions to map a second segment of the different segments to a third channel and a fourth channel of the different channels.

19. The computer program product of claim 17, wherein, the program instructions to perform the write operation comprise:
program instructions to perform the write operation on a first lower page of the storage device using a first channel of the first segment; and
program instructions to perform the write operation on a first lower page of the storage device using a first channel of the second segment.

20. The computer program product of claim 17, wherein the program instructions comprise:
program instructions to alternate between segments based on a range of logical block addresses of the write command.
